(19) United States
(12) Patent Application Publication
(10) Pub. No.: US 2025/0328446 A1
(43) Pub. Date: Oct. 23, 2025

(54) SYSTEM MANAGEMENT INTERRUPT TELEMETRY

(71) Applicant: DELL PRODUCTS L.P., Round Rock, TX (US)

(72) Inventor: Wei G Liu, Austin, TX (US)

(21) Appl. No.: 18/637,862

(22) Filed: Apr. 17, 2024

(51) Int. Cl. G06F 11/34; G06F 11/30

(52) U.S. Cl. CPC G06F 11/3423; G06F 11/3075

(57) ABSTRACT

An information handling system receives a system management interrupt (SMI), and if an SMI telemetry is enabled, then the system reads a first timestamp at an entry point of the SMI. Subsequent to handling the SMI, the system reads a second timestamp at an exit point of the SMI, and calculates a system management mode latency based on a difference between the second timestamp at the exit point and the first timestamp at the entry point.

### FIELD OF THE DISCLOSURE

The present disclosure generally relates to information handling systems, and more particularly relates to system management interrupt telemetry.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

An information handling system receives a system management interrupt (SMI), and if SMI telemetry is enabled, then the system reads a first timestamp at an entry point of the SMI. Subsequent to handling the SMI, the system reads a second timestamp at an exit point of the SMI, and calculates a system management mode latency based on a difference between the second timestamp at the exit point and the first timestamp at the entry point.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system, according to an embodiment of the present disclosure;

FIG. 2 is a block diagram of an information handling system for system management interrupt telemetry, according to an embodiment of the present disclosure; and

FIG. 3 is a flowchart of a method for system management interrupt telemetry, according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

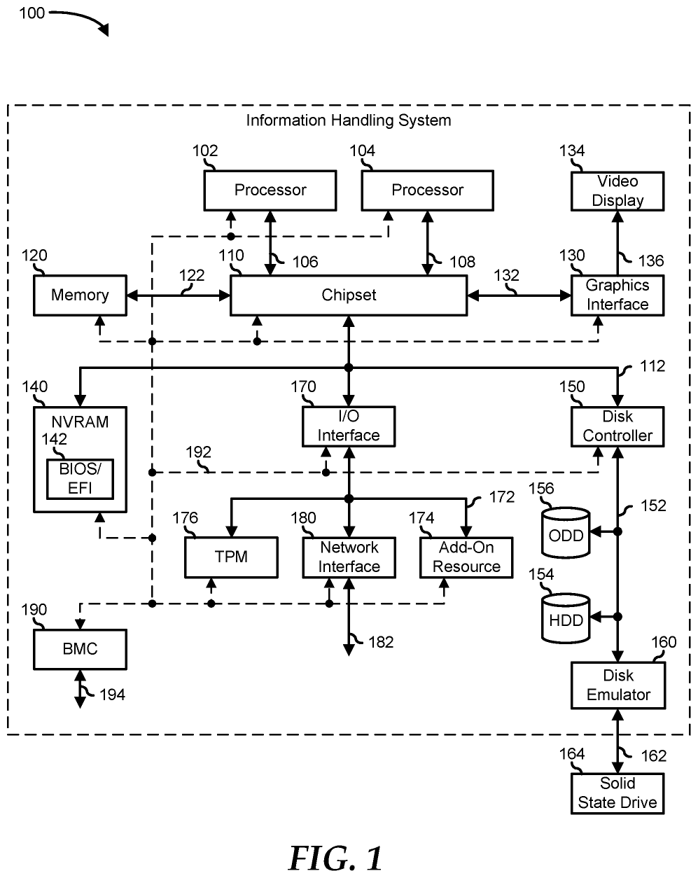

FIG. 1 illustrates an embodiment of an information handling system 100 including processors 102 and 104, a chipset 110, a memory 120, a graphics adapter 130 connected to a video display 134, a non-volatile RAM (NVRAM) 140 that includes a basic input and output system/extensible firmware interface (BIOS/EFI) module 142, a disk controller 150, a hard disk drive (HDD) 154, an optical disk drive 156, a disk emulator 160 connected to a solid-state drive (SSD) 164, an input/output (I/O) interface 170 connected to an add-on resource 174 and a trusted platform module (TPM) 176, a network interface 180, and a baseboard management controller (BMC) 190. Processor 102 is connected to chipset 110 via processor interface 106, and processor 104 is connected to the chipset via processor interface 108. In a particular embodiment, processors 102 and 104 are connected together via a high-capacity coherent fabric, such as a HyperTransport link, a QuickPath Interconnect, or the like. Chipset 110 represents an integrated circuit or group of integrated circuits that manage the data flow between processors 102 and 104 and the other elements of information handling system 100. In a particular embodiment, chipset 110 represents a pair of integrated circuits, such as a northbridge component and a southbridge component. In another embodiment, some or all of the functions and features of chipset 110 are integrated with one or more of processors 102 and 104.

Memory 120 is connected to chipset 110 via a memory interface 122. An example of memory interface 122 includes a Double Data Rate (DDR) memory channel and memory 120 represents one or more DDR Dual In-Line Memory Modules (DIMMs). In a particular embodiment, memory interface 122 represents two or more DDR channels. In another embodiment, one or more of processors 102 and 104 include a memory interface that provides a dedicated memory for the processors. A DDR channel and the connected DDR DIMMs can be in accordance with a particular DDR standard, such as a DDR3 standard, a DDR4 standard, a DDR5 standard, or the like.

Memory 120 may further represent various combinations of memory types, such as Dynamic Random Access Memory (DRAM) DIMMs, Static Random Access Memory (SRAM) DIMMs, non-volatile DIMMs (NV-DIMMs), storage class memory devices, Read-Only Memory (ROM) devices, or the like. Graphics adapter 130 is connected to chipset 110 via a graphics interface 132 and provides a video display output 136 to a video display 134. An example of a graphics interface 132 includes a Peripheral Component Interconnect-Express (PCIe) interface and graphics adapter 130 can include a four-lane (×4) PCIe adapter, an eight-lane (×8) PCIe adapter, a 16-lane (×16) PCIe adapter, or another configuration, as needed or desired. In a particular embodiment, graphics adapter 130 is provided down on a system printed circuit board (PCB). Video display output 136 can include a Digital Video Interface (DVI), a High-Definition Multimedia Interface (HDMI), a DisplayPort interface, or the like, and video display 134 can include a monitor, a smart television, an embedded display such as a laptop computer display, or the like.

NVRAM 140, disk controller 150, and I/O interface 170 are connected to chipset 110 via an I/O channel 112. An example of I/O channel 112 includes one or more point-to-point PCIe links between chipset 110 and each of NVRAM 140, disk controller 150, and I/O interface 170. Chipset 110 can also include one or more other I/O interfaces, including a PCIe interface, an Industry Standard Architecture (ISA) interface, a Small Computer Serial Interface (SCSI) interface, an Inter-Integrated Circuit (I²C) interface, a System Packet Interface, a Universal Serial Bus (USB), another interface, or a combination thereof. NVRAM 140 includes BIOS/EFI module 142 that stores machine-executable code (BIOS/EFI code) that operates to detect the resources of information handling system 100, to provide drivers for the resources, to initialize the resources, and to provide common access mechanisms for the resources. The functions and features of BIOS/EFI module 142 will be further described below.

Disk controller 150 includes a disk interface 152 that connects the disc controller to a hard disk drive (HDD) 154, to an optical disk drive (ODD) 156, and to disk emulator 160. An example of disk interface 152 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 160 permits SSD 164 to be connected to information handling system 100 via an external interface 162. An example of external interface 162 includes a USB interface, an institute of electrical and electronics engineers (IEEE) 1394 (Firewire) interface, a proprietary interface, or a combination thereof. Alternatively, SSD 164 can be disposed within information handling system 100.

I/O interface 170 includes a peripheral interface 172 that connects the I/O interface to add-on resource 174, to TPM 176, and to network interface 180. Peripheral interface 172 can be the same type of interface as I/O channel 112 or can be a different type of interface. As such, I/O interface 170 extends the capacity of I/O channel 112 when peripheral interface 172 and the I/O channel are of the same type, and the I/O interface translates information from a format suitable to the I/O channel to a format suitable to the peripheral interface 172 when they are of a different type. Add-on resource 174 can include a data storage system, an additional graphics interface, a network interface card (NIC), a sound/video processing card, another add-on resource, or a combination thereof. Add-on resource 174 can be on a main circuit board, on separate circuit board, or add-in card disposed within information handling system 100, a device that is external to the information handling system, or a combination thereof.

Network interface 180 represents a network communication device disposed within information handling system 100, on a main circuit board of the information handling system, integrated onto another component such as chipset 110, in another suitable location, or a combination thereof. Network interface 180 includes a network channel 182 that provides an interface to devices that are external to information handling system 100. In a particular embodiment, network channel 182 is of a different type than peripheral interface 172 and network interface 180 translates information from a format suitable to the peripheral channel to a format suitable to external devices.

In a particular embodiment, network interface 180 includes a NIC or host bus adapter (HBA), and an example of network channel 182 includes an InfiniBand channel, a Fibre Channel, a Gigabit Ethernet channel, a proprietary channel architecture, or a combination thereof. In another embodiment, network interface 180 includes a wireless communication interface, and network channel 182 includes a Wi-Fi channel, a near-field communication (NFC) channel, a Bluetooth® or Bluetooth-Low-Energy (BLE) channel, a cellular based interface such as a Global System for Mobile (GSM) interface, a Code-Division Multiple Access (CDMA) interface, a Universal Mobile Telecommunications System (UMTS) interface, a Long-Term Evolution (LTE) interface, or another cellular based interface, or a combination thereof. Network channel 182 can be connected to an external network resource (not illustrated). The network resource can include another information handling system, a data storage system, another network, a grid management system, another suitable resource, or a combination thereof.

BMC 190 is connected to multiple elements of information handling system 100 via one or more management interface 192 to provide out of band monitoring, maintenance, and control of the elements of the information handling system. As such, BMC 190 represents a processing device different from processor 102 and processor 104, which provides various management functions for information handling system 100. For example, BMC 190 may be responsible for power management, cooling management, and the like. The term BMC is often used in the context of server systems, while in a consumer-level device, a BMC may be referred to as an embedded controller (EC). A BMC included in a data storage system can be referred to as a storage enclosure processor. A BMC included at a chassis of a blade server can be referred to as a chassis management controller and embedded controllers included at the blades of the blade server can be referred to as blade management controllers. Capabilities and functions provided by BMC 190 can vary considerably based on the type of information handling system. BMC 190 can operate in accordance with an Intelligent Platform Management Interface (IPMI). Examples of BMC 190 include an Integrated Dell® Remote Access Controller (iDRAC).

Management interface 192 represents one or more out-of-band communication interfaces between BMC 190 and the elements of information handling system 100, and can include an Inter-Integrated Circuit (I2C) bus, a System Management Bus (SMBUS), a Power Management Bus (PMBUS), a Low Pin Count (LPC) interface, a serial bus such as a Universal Serial Bus (USB) or a Serial Peripheral Interface (SPI), a network interface such as an Ethernet interface, a high-speed serial data link such as a PCIe interface, a Network Controller Sideband Interface (NC-SI), or the like. As used herein, out-of-band access refers to operations performed apart from a BIOS/operating system execution environment on information handling system 100, that is apart from the execution of code by processors 102 and 104 and procedures that are implemented on the information handling system in response to the executed code.

BMC 190 operates to monitor and maintain system firmware, such as code stored in BIOS/EFI module 142, option ROMs for graphics adapter 130, disk controller 150, add-on resource 174, network interface 180, or other elements of information handling system 100, as needed or desired. In particular, BMC 190 includes a network interface 194 that can be connected to a remote management system to receive firmware updates, as needed or desired. Here, BMC 190 receives the firmware updates, stores the updates to a data storage device associated with the BMC and transfers the firmware updates to the NVRAM of the device or system that is the subject of the firmware update, thereby replacing the currently operating firmware associated with the device or system, and reboots information handling system, whereupon the device or system utilizes the updated firmware image.

BMC 190 utilizes various protocols and application programming interfaces (APIs) to direct and control the processes for monitoring and maintaining the system firmware. An example of a protocol or API for monitoring and maintaining the system firmware includes a graphical user interface (GUI) associated with BMC 190, an interface defined by the Distributed Management Taskforce (DMTF) (such as a Web Services Management (WSMan) interface, a Management Component Transport Protocol (MCTP) or, a Redfish® interface), various vendor defined interfaces (such as a Dell EMC Remote Access Controller Administrator (RACADM) utility, a Dell EMC OpenManage Enterprise, a Dell EMC OpenManage Server Administrator (OMSA) utility, a Dell EMC OpenManage Storage Services (OMSS) utility, or a Dell EMC OpenManage Deployment Toolkit (DTK) suite), a BIOS setup utility such as invoked by a “F2” boot option, or another protocol or API, as needed or desired.

In a particular embodiment, BMC 190 is included on a main circuit board (such as a baseboard, a motherboard, or any combination thereof) of information handling system 100 or is integrated onto another element of the information handling system such as chipset 110, or another suitable element, as needed or desired. As such, BMC 190 can be part of an integrated circuit or a chipset within information handling system 100. An example of BMC 190 includes an iDRAC, or the like. BMC 190 may operate on a separate power plane from other resources in information handling system 100. Thus BMC 190 can communicate with the management system via network interface 194 while the resources of information handling system 100 are powered off. Here, information can be sent from the management system to BMC 190 and the information can be stored in a RAM or NVRAM associated with the BMC. Information stored in the RAM may be lost after power-down of the power plane for BMC 190, while information stored in the NVRAM may be saved through a power-down/power-up cycle of the power plane for the BMC.

Information handling system 100 can include additional components and additional busses, not shown for clarity. For example, information handling system 100 can include multiple processor cores, audio devices, and the like. While a particular arrangement of bus technologies and interconnections is illustrated for the purpose of example, one of skill will appreciate that the techniques disclosed herein are applicable to other system architectures. Information handling system 100 can include multiple central processing units (CPUs) and redundant bus controllers. One or more components can be integrated together. Information handling system 100 can include additional buses and bus protocols, for example, I2C and the like. Additional components of information handling system 100 can include one or more storage devices that can store machine-executable code, one or more communications ports for communicating with external devices, and various input and output (I/O) devices, such as a keyboard, a mouse, and a video display.

For purposes of this disclosure information handling system 100 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 100 can be a personal computer, a laptop computer, a smartphone, a tablet device or other consumer electronic device, a network server, a network storage device, a switch, a router, or another network communication device, or any other suitable device and may vary in size, shape, performance, functionality, and price. Further, information handling system 100 can include processing resources for executing machine-executable code, such as processor 102, a programmable logic array (PLA), an embedded device such as a System-on-a-Chip (SoC), or other control logic hardware. Information handling system 100 can also include one or more computer-readable media for storing machine-executable code, such as software or data.

System management mode (SMM) is a processor state that is used for system management operations. The SMM operates at a higher privilege level than an operating system and a hypervisor. In addition, the SMM is designed to be stealthy and opaque to the operating system and the hypervisor. To enter the SMM from the operating system runtime, a system management interrupt (SMI) is generated. In response to the SMI, a platform firmware or BIOS suspends normal execution by storing a state of a CPU in a region of RAM, performs a requested SMI task within the SMM, and resumes normal operation by restoring the CPU from the stored state.

The SMI is typically used in the BIOS for system management, chipset workaround, and reliability, availability, and serviceability handling, among others. The SMI may also be performed for signature verification, data analysis, and/or transfer and firmware management operations. An SMI task performed for a substantial amount of time may cause the operating system runtime issues, such as network packet loss, watchdog timer timeout, etc. This is because the SMI task can bring CPU cores into the SMM without the operating system being aware. Also, SMI latency scales with the number of CPU cores. Thus when frequent and lengthy SMI tasks occur, such as in an SMI storm, the performance of an information handling system can be impacted. For example if a user is playing media when a lengthy SMI task is performed, there may be a noticeable glitch in audio or video playback due to the suspension of the audio or the video playback during the performance of the SMI task.

There is no easy method for customers to collect information associated with the SMI such as an SMI count and latency. When the information handling system exhibits sluggishness in the field, it is common for the user or support personnel to suspect that the issue is SMI-related but have no telemetry data to support the suspicion. Thus, a system and method for SMI telemetry collection is proposed to allow or assist the user or the support personnel in identifying and debugging suspected SMI-related issues.

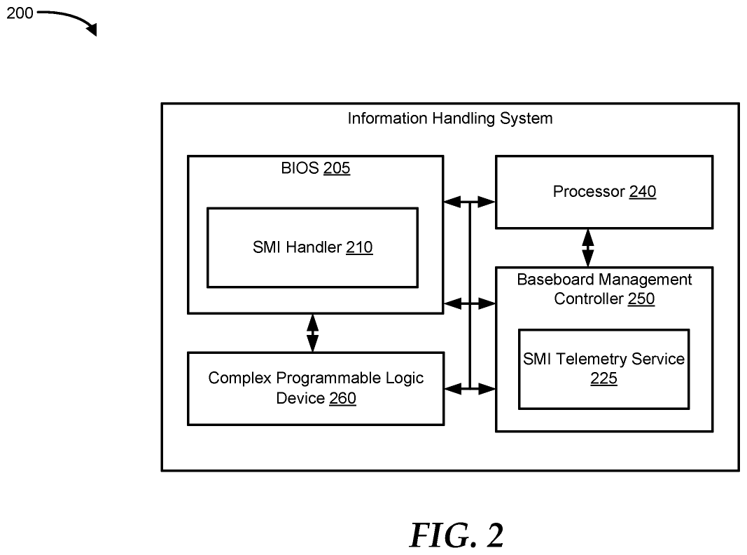

FIG. 2 shows a portion of an information handling system 200 for SMI telemetry collection. Information handling system 200 includes a BIOS 205, a processor 240, a BMC 250, and a complex programmable logic device (CPLD) 260. BIOS 205, which is similar to BIOS 142 of FIG. 1, includes an SMI handler 210. Processor 240 is similar to processors 102 and 104 of FIG. 1. BMC 250, which is similar to BMC 190 of FIG. 1, includes an SMI telemetry service 225. BIOS 205 may be communicatively coupled to processor 240, BMC 250, and CPLD 260. For example, communication between BIOS 205 and BMC 250 may be performed using an IPMI command or a complex programmable logic device (CPLD) handshake. However, any variety of connections between BIOS 205, processor 240, BMC 250, and CPLD 260 are envisioned as falling within the scope of the present disclosure. The components of information handling system 200 may be implemented in hardware, software, firmware, or any combination thereof. The components shown are not drawn to scale and information handling system 200 may include additional or fewer components. In addition, connections between components may be omitted for descriptive clarity. The operations described herein as being performed by BIOS 205 or BMC 250 may be performed or executed by processor 240.

The SMI telemetry collection, which is performed when enabled, may include gathering information associated with each SMI received by SMI handler 210, such as a duration of the SMI and a number of SMIs received. Because thousands of SMIs can happen as part of a power-on self-test during the BIOS boot-up process, an SMI telemetry mode is typically enabled or activated automatically when advanced configuration and power interface is set to ON state or when an operating system takes control of information handling system 200 and terminates boot services with a call to ExitBootServices( ). However, there is generally an expectation that the occurrence of an SMI is rare once the operating system is up and running because various checkpoints may have been completed at that point. As such, the SMI telemetry mode is enabled at this point. Accordingly, information, such as timestamps, SMI duration or SMI latency, among others may be logged as SMI telemetry data. The SMI telemetry data may also be available on demand, such as via a report from BMC 250.

When the SMI is received by SMI handler 210, information handling system 200 may enter an SMM of operation, which may take CPU time away from the operating system and/or a hypervisor. Thus, it may be desirable to determine the amount of time that information handling system 200 is in the SMM of operation, which is an amount of time between suspension and resumption of normal operation, also referred to as SMM latency. SMM latency can also be equivalent to the duration of the received SMI. A typical SMI duration is around two milliseconds, which can be used as a threshold. However, the threshold may be adjusted by a system administrator or via a BIOS update. Accordingly, it would be desirable to determine the SMI duration and whether the duration of the received SMI exceeds the threshold. In addition, information on how many SMIs exceeded the threshold may also be desirable.

To determine the SMM latency, SMI handler 210 may be configured to log a timestamp T1 at an SMI entry point. Similarly, SMI handler 210 may be configured to log a timestamp T2 at an SMI exit point right before a resume instruction. However, SMI handler 210 may log the timestamp T2 when the operating system exits SMM when the information handling system is reset or shut down. SMI handler 210 may store both the timestamps T1 and T2 at a buffer accessible by BIOS 205 and BMC 250 or SMI telemetry service 225 in particular. SMI handler 210 can also determine an approximate time that the CPU core stayed inside an SMM, also referred to as the SMM latency based on a difference between the timestamp T2 and the timestamp T1. SMI handler 210 may keep track of the duration of each SMI received. In addition, SMI handler 210 can also keep track of an SMI with the longest duration among SMI duration values. For example, given a first SMI associated with a first SMI duration and a second SMI associated with a second SMI duration, wherein the second SMI duration is longer than the first SMI duration, SMI handler 210 may store the value of the second SMI duration in the buffer. SMI handler 210 may overwrite the first SMI duration if stored. Further, SMI handler 210 may also use an SMI counter to keep track of how many SMIs have occurred. For example, BIOS 205 can increment the SMI counter inside the SMM handler when the SMI is received.

Instead of storing the SMI-related data in the buffer as mentioned above, SMI handler 210 may store the SMI-related data in a CPLD register, such as a register of CPLD 260. The register may also be accessible by BIOS 205 and BMC 250. The CPLD register may be a preferred embodiment over the IPMI command as it is a faster interface in comparison to the IPMI command. The data stored at the buffer, or the register may be refreshed at each boot or kept for the life of information handling system 200. For example, the SMI counter may be reset at each boot. In another example, the SMI counter may not be reset at each boot to show a total number of SMIs received during the life of information handling system 200. Similarly, SMI telemetry service 225 may keep track of the longest SMI duration from the last boot or for the life of information handling system 200. Other information associated with the SMI aside from the SMI count and the longer SMI duration may also be stored, such as the SMI duration of each SMI received, the timestamps T1 and T2, SMI identifier, etc.

In one embodiment, SMI telemetry collection may be performed when information handling system 200 is about to be reset or shut down. For example, SMI telemetry service 225 may collect data associated with one or more SMIs from the buffer or read the data from a register of CPLD 260 when information handling system 200 is about to be reset or shut down. BMC 250 can present the data collected as SMI telemetry data and include it as part of a report to support engineers in resolving platform and system problems. BMC 250 can also include the SMI telemetry data as part of a lifecycle log. In another embodiment, the SMI telemetry collection can be performed periodically. For example, SMI telemetry service 225 can poll the buffer or read the register of CPLD 260 at a desired pre-determined interval, such as hourly, daily, etc. In yet another embodiment, the SMI telemetry collection can be performed on demand. For example, a support engineer may request BMC 250 for the SMI telemetry data, and SMI telemetry service 225 can then collect the data from the buffer or read the data from the register.

Those of ordinary skill in the art will appreciate that the configuration, hardware, and/or software components of information handling system 200 depicted in FIG. 2 may vary. For example, the illustrative components within information handling system 200 are not intended to be exhaustive, but rather are representative to highlight components that can be utilized to implement aspects of the present disclosure. For example, other devices and/or components may be used in addition to or in place of the devices/components depicted. The depicted example does not convey or imply any architectural or other limitations with respect to the presently described embodiments and/or the general disclosure. In the discussion of the figures, reference may also be made to components illustrated in other figures for continuity of the description.

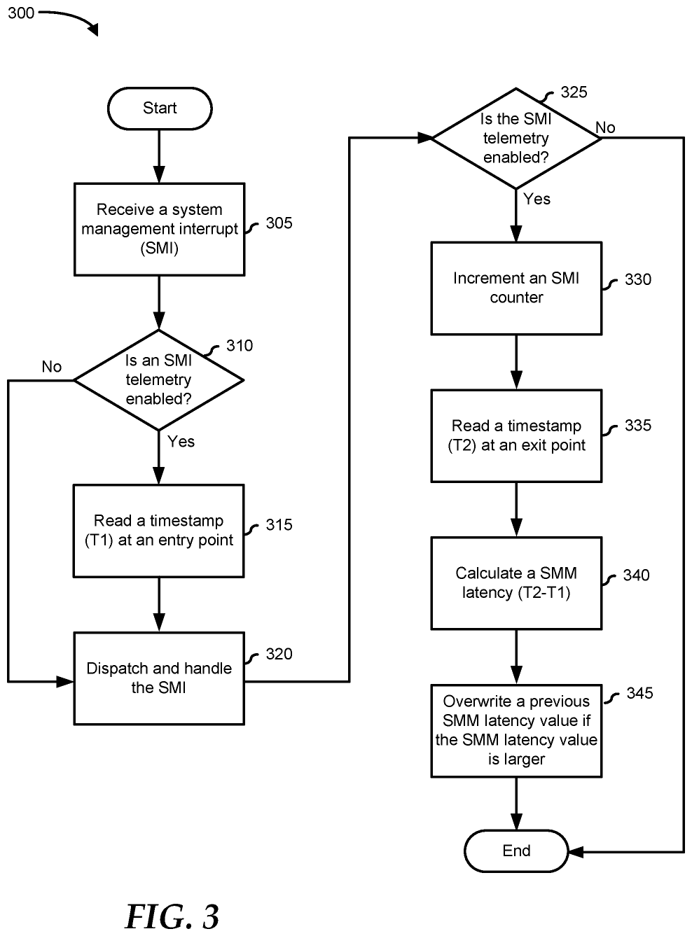

FIG. 3 shows a flowchart of method 300 for SMI telemetry collection. Method 300 may be performed by any suitable component of information handling system 200 including, but not limited to BIOS 205 and BMC 250 of FIG. 2. While embodiments of the present disclosure are described in terms of the components of information handling system 200 of FIG. 2, it should be recognized that other components may be utilized to perform the described method. One of skill in the art will appreciate that this flowchart explains a typical example, which can be extended to applications or services in practice.

Method 300 typically starts at block 305 where an SMI is received, wherein the SMI can be associated with a set of instructions. The SMI may be dispatched to an appropriate SMI handler entry in the set of instructions. When the SMI is received, the information handling system goes into an SMM operating mode in which normal execution including the operating system is suspended. The SMM operating mode typically supports power management, system hardware control, or proprietary original equipment manufacturer program code. SMM is intended for use by system firmware and provides an isolated processor environment that operates transparently to the operating system and software applications. SMM can be entered in response to an SMI, which can either be hardware or software generated.

The method proceeds to decision block 310 where SMI handler 210 may determine whether SMI telemetry is enabled. The SMI telemetry may be enabled by default, such as when the boot process is successful. In addition, an option may be used to enable or disable the SMI telemetry, such as by a system administrator. If the SMI telemetry is enabled, then the “YES” branch is taken, and the method proceeds to block 315. If the SMI telemetry is not enabled, then the “NO” branch is taken, and the method proceeds to block 320. At block 315, SMI handler 210 may read a timestamp T1 at an entry point. The method proceeds to block 320 where the SMI is dispatched and handled as appropriate. The SMI code may be initialized, and the CPU may be transitioned to a protected mode. The operating system execution may be suspended for the entire time SMI handler 210 is executing the SMI code.

The method proceeds to decision block 325 where SMI handler 210 may determine whether SMI telemetry is enabled. If the SMI telemetry is enabled, then the “YES” branch is taken, and the method proceeds to block 330. If the SMI telemetry is not enabled, then the “NO” branch is taken, and the method ends. At block 330, SMI handler 210 may increment an SMI counter. The method proceeds to block 335, where the SMI handler 210 may read a timestamp T2 at an exit point. At this point, the information handling system may exit the set of instructions and the SMM operating mode. Subsequently, the normal execution may be restored. The method proceeds to block 340, where SMI handler 210 may calculate an SMM latency value or duration of the received SMI. The SMM latency value may be calculated as a difference between a timestamp at the exit point and the entry point.

The method proceeds to lock 345, where SMI handler 210 may store the SMM latency value at a buffer or a CPLD register, wherein both the buffer and the CPLD register are accessible by SMI telemetry service 225. SMI handler 210 may overwrite a previous SMM latency value stored in the buffer or the CPLD register if the SMM latency value calculated at block 340 is larger than the previous SMM latency value. Afterwards, the method ends.

Although FIG. 3 shows example blocks of method 300 in some implementations, method 300 may include additional blocks, fewer blocks, different blocks, or differently arranged blocks than those depicted in FIG. 3. Those skilled in the art will understand that the principles presented herein may be implemented in any suitably arranged processing system. Additionally, or alternatively, two or more of the blocks of method 300 may be performed in parallel. For example, blocks 330 and 335 of method 300 may be performed in parallel.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionalities as described herein.

When referred to as a “device,” a “module,” a “unit,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device).

The present disclosure contemplates a computer-readable medium that includes instructions or receives and executes instructions responsive to a propagated signal; so that a device connected to a network can communicate voice, video, or data over the network. Further, the instructions may be transmitted or received over the network via the network interface device.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes, or another storage device to store information received via carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents but also equivalent structures.

What is claimed is:

1. A method comprising:
receiving, by a processor, a system management interrupt (SMI) at an information handling system;
if SMI telemetry is enabled, then reading a first timestamp at an entry point of the SMI;
subsequent to handling the SMI, reading a second timestamp at an exit point of the SMI; and
calculating a system management mode (SMM) latency based on a difference between the second timestamp at the exit point and the first timestamp at the entry point.

2. The method of claim 1, wherein the reading of the first timestamp is performed prior to handling the SMI.

3. The method of claim 1, further comprising determining whether the SMM latency is longer than another SMM latency.

4. The method of claim 3, further comprising storing a value of the SMM latency if the SMM latency is longer than the other SMM latency.

5. The method of claim 4, wherein the storing of the value of the SMM latency includes overwriting a previous SMM latency.

6. The method of claim 4, wherein the value of the SMM latency is stored in a complex programmable logic device register.

7. The method of claim 4, wherein the value of the SMM latency is stored in a buffer accessible by a baseboard management controller.

8. The method of claim 4, wherein the value of the SMM latency is provided as telemetry data by a baseboard management controller.

9. The method of claim 1, further comprising incrementing an SMI counter.

10. The method of claim 1, further comprising logging the first timestamp and the first timestamp as SMI telemetry data.

11. An information handling system, comprising:
a processor; and
a memory storing instructions that when executed cause the processor to perform operations including:
receiving a system management interrupt (SMI) at the information handling system;
if an SMI telemetry is enabled, then reading a first timestamp at an entry point of the SMI;
subsequent to handling the SMI, reading a second timestamp at an exit point of the SMI; and
calculating a system management mode (SMM) latency based on a difference between the second timestamp at the exit point and the first timestamp at the entry point.

12. The information handling system of claim 11, wherein the operations further comprise determining whether the SMM latency is longer than another SMM latency.

13. The information handling system of claim 12, wherein the operations further comprise storing a value of the SMM latency if the SMM latency is longer than the other SMM latency.

14. The information handling system of claim 13, wherein the storing of the value of the SMM latency includes overwriting a previous SMM latency.

15. The information handling system of claim 13, wherein the value of the SMM latency is stored in a complex programmable logic device register.

16. The information handling system of claim 13, wherein the value of the SMM latency is stored in a buffer accessible by a baseboard management controller.

17. A non-transitory computer-readable medium to store instructions that are executable to perform operations comprising:
receiving a system management interrupt (SMI) at an information handling system;
if an SMI telemetry is enabled, then reading a first timestamp at an entry point of the SMI;
subsequent to handling the SMI, reading a second timestamp at an exit point of the SMI; and
calculating a system management mode (SMM) latency based on a difference between the second timestamp at the exit point and the first timestamp at the entry point.

18. The non-transitory computer-readable medium of claim 17, wherein the operations further comprise determining whether the SMM latency is longer than another SMM latency.

19. The non-transitory computer-readable medium of claim 17, wherein the operations further comprise storing a value of the SMM latency if the SMM latency is longer than the other SMM latency.

20. The non-transitory computer-readable medium of claim 19, wherein the value of the SMM latency is stored in a complex programmable logic device register.
